(19) United States
(12) Patent Application Publication
(10) Pub. No.: US 2008/0190283 A1
(43) Pub. Date: Aug. 14, 2008

(54) System and Method for Mounting and Demounting Cylinder Unit in Vehicle

(75) Inventors: Morten Berger Gunnerud, Kongsberg (NO); Lucien Lenerand, Kongsberg (NO)

Correspondence Address: EDWARDS ANGELL PALMER & DODGE LLP, P.O. BOX 55874, BOSTON, MA, 02205, US

(73) Assignee: KONGSBERG AUTOMOTIVE AS, Kongsberg (NO)

(21) Appl. No.: 12/064,459

(22) PCT Filed: Aug. 7, 2006
(86) PCT No.: PCT/NO2006/000292

§ 371 Date: Feb. 22, 2008

(30) Foreign Application Priority Data
Aug. 24, 2005 (SE) 0501882-5

(51) Int. Cl. F15B 15/26

(52) U.S. Cl. 92/23; 92/27

(57) ABSTRACT

A system for mounting or/demounting a cylinder unit (1) in a vehicle. A piston rod (5) provided with a piston (4) arranged in the bore (6) of the cylinder unit (1) which piston (4) and piston rod (5) are displaceably arranged in the axial direction of the bore (6) of the cylinder unit. The bore (6) has an opening (13) provided for an end portion of the piston rod (5) to protrude out from the bore, and the piston (4) separates the cylinder unit into a first chamber (7) and a second chamber (8) . At least a first passage (9) is provided for communication of fluid into or out of the first chamber (7) . In an initial operating position of the cylinder unit, the piston (4) and the piston rod (5) is positioned with the end portion of the piston (5) protruding out from the mouth of the bore (6). In a mounting/demounting position of the cylinder unit, pressuriized fluid is introduced into the first chamber (7) preferably through the first passage (9) thereby placing the piston (4) and the piston rod (5) in a mounting/demounting position where the end portion of the piston rod (5) essentially retracted in the bore. The invention also concerns a method for mounting/demounting the cylinder unit.

The invention concerns a system for mounting and/or demounting a cylinder unit in a vehicle, and methods for mounting/demounting a cylinder unit provided in a element which is removably arranged in a vehicle.

When mounting a cylinder unit with a protruding piston rod in accordance with prior art, the rod is manually retracted into the cylinder unit and locked by inserting a holding device such as for instance a stick or a shaft. The holding device keeps the piston rod in place in a retracted position in order to fit the cylinder unit into mounting position. The holding device is thereafter removed in order to release the piston rod to an initial position ready to be operated.

U.S. Pat. No. 5,295,566 shows a solution demanding a mechanical holding device to be used during installation of a cylinder unit with a protruding piston rod.

The solution in accordance with prior art includes the use of a specific mechanical tool for installation purposes. Furthermore, when installing the cylinder unit, the assembler must physically operate the retraction of the piston rod. Consequently, the installation procedure in accordance with prior art is quite cumbersome and not very efficient. However, a more significant restriction is the fact that the prior art solution is not applicable for dismounting the cylinder. The known solution is merely suitable when installing the cylinder unit and does not suggest a procedure for demounting the cylinder unit in the case of maintenance or replacement of the cylinder unit.

It is an object of the invention to provide a solution including procedures both for mounting and demounting of a cylinder unit of the kind mentioned in the preamble of the independent claims. A further object of the invention is to provide a solution where there is basically no need for the assembler to interfere physically with the protruding piston rod of cylinder unit.

The object of the invention is obtained by the invention as defined in the independent claims 1, 15, 17 wherein embodiments of the invention is presented in the proceeding dependent claims.

The invention in accordance with independent claim 1 comprises a system for mounting and/or demounting a cylinder unit in/from a vehicle. A piston rod provided with a piston is arranged in the bore of the cylinder unit. The piston and piston rod are arranged to be displaced in the axial direction of the bore of the cylinder unit. The bore has an opening provided for an end portion of the piston rod to protrude out from the bore. The piston separates the cylinder unit into a first chamber and a second chamber wherein at least a first passage is provided for communication of fluid into or out of the first chamber. In an initial position where the cylinder unit is prepared to be operated, the piston and the piston rod is positioned so that the end portion of the piston protrudes out from the mouth of the bore. When preparing the cylinder unit to be mounted into a structure of the vehicle or demounted from the structure of the vehicle, pressurized fluid is introduced into the first chamber preferably through the first passage thereby placing the piston and the piston rod in a mounting/demounting position. In this position the end portion of the piston rod is essentially retracted in the bore. By this arrangement the cylinder unit may easily be mounted into or demounted from the structure of the vehicle.

The pressurized fluid utilized to bring the piston and the piston rod in a mounting/demounting position may be hydraulic or pneumatic, preferably a pneumatic source will be used for the supply of pressurized fluid. Introduction of pressurized fluid into the first chamber causes the pressure in the first chamber to rise, thereby moving the piston and the piston rod away from the mouth of the bore and further into the bore to retract the end portion of the piston rod.

The first chamber may be provided with some kind of outlet for letting excessive fluid out of the first chamber, when the piston and piston rod are returning to initial position. The first passage may function as an outlet and may in one embodiment may be provided with a mouth communicating with the atmosphere. Further the first passage may be provided with an exhaust cap. Alternatively an exhaust chamber may provided for fluid vented out from the first chamber.

The pressurized fluid may be provided by an existing source present in the vehicle, such as the air source used for the braking system. Preferably a first valve is provided to control the communication of fluid from the existing source to the first passage.

Alternatively, the pressurized fluid may be provided by an external source which is arranged for connection to the first passage.

The system may be provided with a second valve to control the communication of fluid between first passage and atmosphere. The second valve may be used when pressurized fluid is provided by an external source. The second valve then opens and closes for the fluid entering the first chamber through the first passage. Further, regulating the pressure in the first chamber to place the piston rod in a mounting/dismounting may be carried out by means of the second valve. The second valve may be opened after completing the mounting/dismounting of the cylinder unit to vent out the first chamber and to bring piston and piston rod into an initial operating position.

For venting purposes the second valve may also be provided in a system using an existing source. Alternatively a two way valve may be provided to control the communication of fluid from the first passage to atmosphere and to control the communication of fluid from the existing source to the first passage.

The cylinder unit to be used in the system according to invention may be a slave cylinder, a clutch actuator, a gear actuator or any other device fitting in a vehicle.

The current invention also includes methods for mounting/demounting a cylinder unit included in an element which is removably arranged in a vehicle. In one embodiment this element is a shift-control unit which is removably arranged in a structure of the vehicle.

When carrying out the method for mounting/demounting using an external source of pressurized fluid, the method comprises the steps of connecting an external source of pressurized fluid to the first passage and letting fluid into the first chamber. The first passage may be provided with a nipple for the connection of a tube pipelining between the first passage and the source. The inlet of fluid into the passage may be admitted by opening a second valve. After admitting access of fluid into the first chamber the pressure in the first chambers is regulated to place the piston and the piston rod in a position where the end portion is essentially retracted in the bore. This regulation may be carried out by the second valve. When the end portion is retracted in the bore, the element is ready to be inserted into or removed from the vehicle. Thereafter the external source is disconnected. The second valve may be used to stop fluid from entering the first chamber, before disconnecting the source from the nipple. After removing the external source the piston and the piston rod will return to initial operating positions and the excess fluid in the first chamber will be aired out, for instance by opening the second valve.

When carrying out the method for mounting/demounting using an existing source of pressurized fluid, the method comprises the steps of introducing fluid into the first chamber from a source of pressurized fluid provided in the vehicle. The inlet of fluid into the passage may be admitted by opening a first valve. Thereafter the the pressure in the first chamber is regulated to place the piston and the piston rod in a position where the end portion is essentially retracted in the bore. This regulation may be carried out by a second valve. When the end portion is placed in the bore, the element is ready to be inserted into or removed from the structure of the vehicle. Thereafter the pressurized fluid is stopped from entering the first chamber, this might be carried out by closing the first valve.

The second valve, preferably providing communication between atmosphere and the first passage, may be brought to a closed position before introducing fluid into the first chamber. The second valve is held in a closed position during mounting/demounting of the element. After mounting/demounting the second valve may be opened to bring the piston rod into an intial operating position.

The invention will now be explained by an example with reference to the drawings, wherein

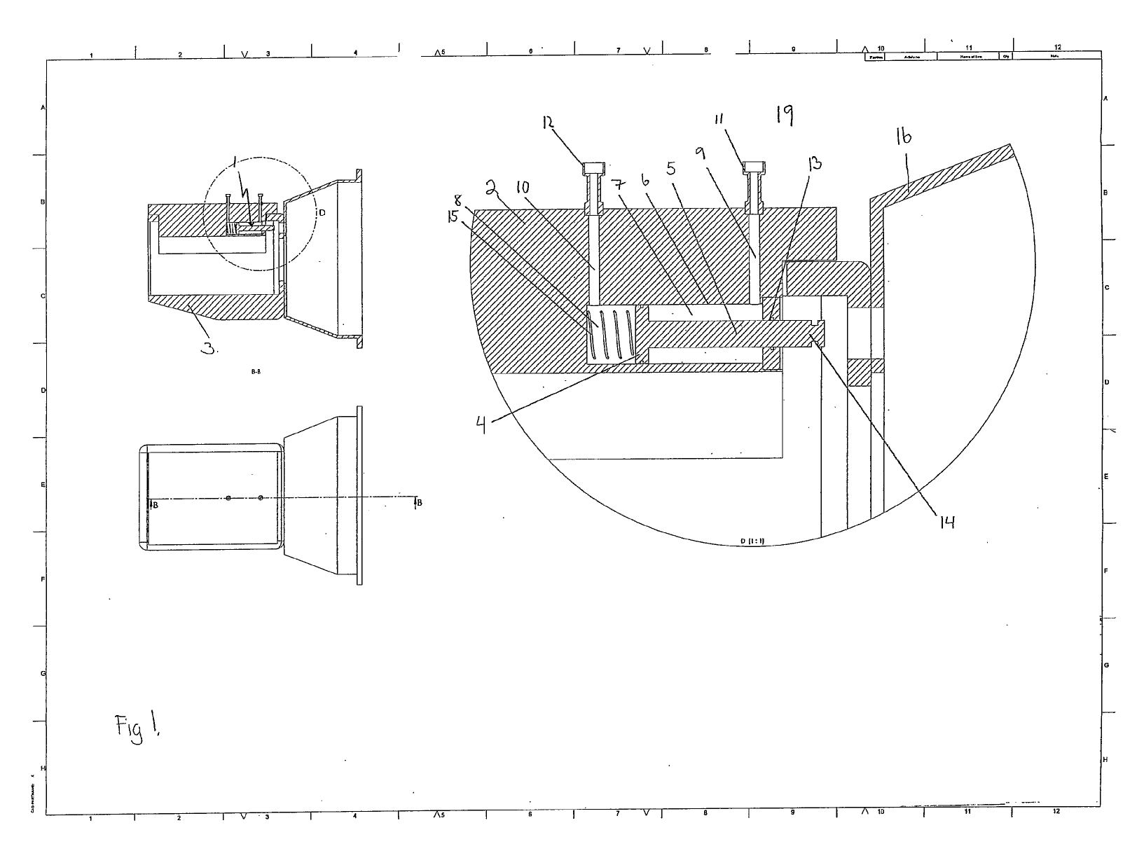

FIG. 1 shows a first embodiment of the invention in an installed position.

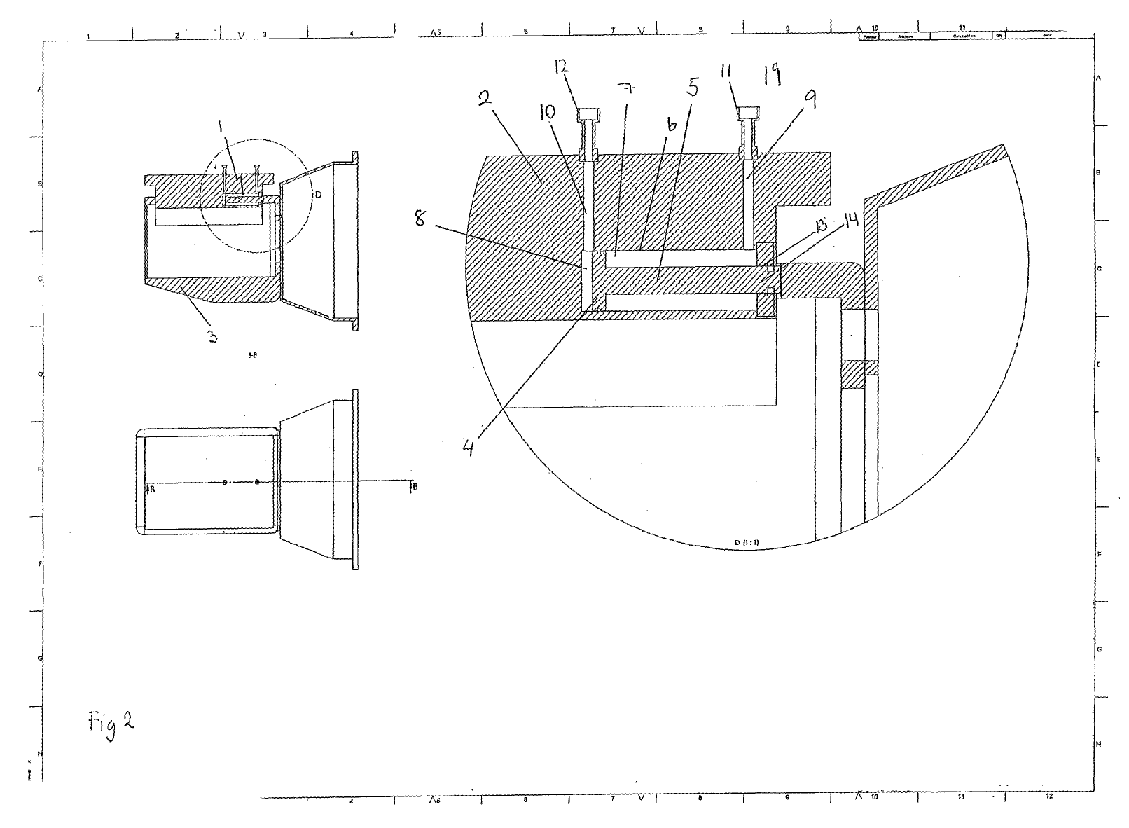

FIG. 2 shows a first embodiment of the invention in an installation position.

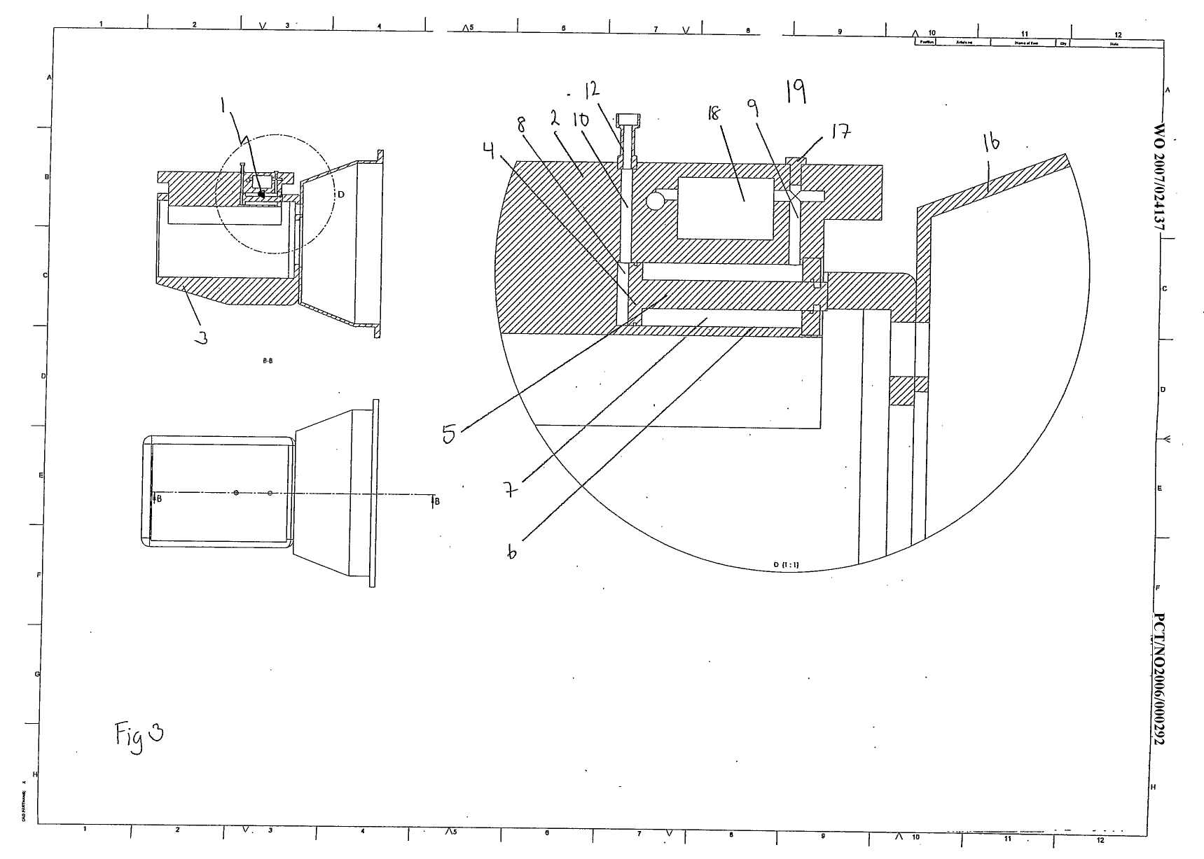

FIG. 3 shows a second embodiment of the invention in an installed position.

FIG. 1 shows a cylinder unit 1 provided in an element such as a shift-control unit 2. The shift-control unit 2 as shown in FIG. 1 is inserted into a gear box 3, and is provided for subsequently removal in the case of maintenance etc. The cylinder unit 1 comprises a piston 4 having an integrated piston rod 5. Alternatively the piston rod 5 and the piston 4 may provided as separate elements which are connected to each other. The piston 4 and the piston rod 5 is arranged to be moved in the axial direction of the bore 6 of the cylinder unit 1. The bore 6 has an opening 13 provided for an end portion 14 of the piston rod 5 to protrude out from the bore. The end portion 14 might be connected to a transfer rod (not shown) for operation of a clutch (illustrated by a clutch housing 16). The piston 4 divides the bore 6 into a first chamber 7 and a second chamber 8, wherein a spring element 15 is arranged. A first passage 9 communicates with the first chamber 7 and a second passage 10 communicates with the second chamber 8. First and second passages 9, 10 are provided with first and second nipples 11, 12. Preferably first chamber 7 and first passage 9 constitute the pneumatic part of the cylinder unit 1, and second chamber 8 and second passage 9 constitute the hydraulic part of the cylinder unit 1. The piston 4 and the piston rod 5 is shown placed into an initial operating position, wherein the end portion of the piston rod is to be connected to a transfer rod preparing the system for the operation of the clutch.

During installation or removing of the shift-control unit 2, as illustrated in FIG. 2 pressurized pneumatic fluid is led through the first passage 9 and into the first chamber 7, by connecting a source of pressurized fluid directly or indirectly to the nipple 11. The source of pressurized fluid may be an external source located outside the vehicle. By introducing pressurized fluid into the first chamber 7, the pressure in the first chamber 7 increases. The rise in pressure in the first chamber 7 causes the piston and the piston rod to move further into the bore 6 away from the opening 13 of the bore 6. FIG. 1 shows a situation wherein the piston rod is essentially retracted in the bore 6, thereby arranging for unobstructed insert or removal of the shift-control unit 2.

After the installation or removal of the shift-control unit 2 has been completed, the flow of fluid into the first chamber 1 is terminated by disconnecting the external source from the nipple 11. Due to the force of the spring element 15 or hydraulic fluid inserted into the first chamber 7, the piston 4 and piston rod 13 will return to the position as illustrated in FIG. 2. The pressurized fluid previously inserted into the first chamber 7, escapes through the first passage 9.

The first passage 9 may be provided with an exhaust cover. In one further embodiment of this first embodiment of the invention a valve-herein called a second valve-(not shown in the figure) may be provided in the first passage 9 to control the communication into and out of the first passage 9. The second valve may be used to control the amount of pressurized fluid entering and escaping from the first chamber 7 through the first passage 9. The second valve may be used to vent out the first chamber 7 to return the piston 4 and the piston rod 5 to the initial operating position in FIG. 1. Alternatively the system may be arranged with an exhaust chamber (not shown) provided for the pressurized fluid escaping the first chamber 7.

A second embodiment of the invention is illustrated in FIG. 3. A first valve 18 is included in the shift-control unit 2. The first valve 18 may be mechanical or electrical or of any kind suitable for this kind of use. In accordance with this embodiment the pressurized fluid is provided by a source present in the vehicle for instance an air source used in the brake system of the vehicle. The first valve 18 controls the flow of pressurized fluid into the passage 9. The first valve 18 is opened to introduce pressurized fluid into the passage 9 and the first chamber 7. Thereafter the pressure in the first chamber 7 is regulated by the first valve 18 to retract the piston 4 and the piston rod in the bore 6 into the position as illustrated in FIG. 3. After the shift-control unit 2 have been installed or removed the flow of pressurized fluid is stopped using the first valve 18. A closure such as a plug 17 is inserted into the passage 9 during the inlet of pressurized fluid from the source. The plug 17 may be removed for venting out the first chamber 7, when the installation/removal of the shift-control unit 2 has been completed. Alternatively a second valve may be provided, controlling the communication between the first passage 9 and the atmosphere 19. The second valve may be opened venting out the first chamber 7, thereby bringing the piston 4 and the piston rod 5 into the initial operating position. Alternatively the system may be arranged with an exhaust chamber (not shown) providing for the pressurized fluid escaping from the first chamber 7. The first passage 9 may be provided with an exhaust cover.

1-19. (canceled)

20. A system for mounting and demounting a cylinder unit in a vehicle, comprising:
a piston arranged in a bore of the cylinder unit, the piston including a piston rod configured to move in an axial direction through the bore, the piston separating the bore into a first chamber and a second chamber;
at least a first passage provided in fluid communication with the first chamber; and
the cylinder unit being configurable in at least an operating position and a mounting/demounting position such that introduction or removal of pressurized fluid from the first chamber causes the piston to move in the axial direction.

21. The system of claim 20, wherein the piston rod includes an end portion configured to protrude out an opening of the bore.

22. The system of claim 21, wherein in the operating position, the end portion of the piston rod protrudes out the opening of the bore.

23. The system of claim 21, wherein in the mounting/demounting position, the end portion of the piston rod is retracted in the bore.

24. The system of claim 20, wherein the pressurized fluid is hydraulic or pneumatic.

25. The system of claim 20, wherein in the mounting/demounting position, the cylinder unit is configured to be mounted or demounted from the vehicle.

26. The system of claim 20, wherein the first passage is provided with an exhaust cover.

27. The system of claim 20, wherein the first passage is provided with an exhaust chamber for venting of the pressurized fluid.

28. The system of claim 20, wherein the first passage is provided with a nipple.

29. The system of claim 20, wherein the pressurized fluid is operably connected to the first passage from an external source.

30. The system of claim 20, wherein the pressurized fluid is operably connected to the first passage from a source internal to the vehicle.

31. The system of claim 20, further comprising a first valve for controlling a flow of the pressurized fluid into the first passage.

32. The system of claim 31, further comprising a second valve for controlling a flow of the pressurized fluid between the first passage and the atmosphere.

33. The system of claim 20, further comprising a two-way valve for controlling a flow of the pressurized fluid into the first passage and venting the pressurized fluid to the atmosphere.

34. The system of claim 20, wherein the cylinder unit is selected from the group consisting of: a slave cylinder, a clutch, and a gear actuator.

35. The system of claim 20, wherein the cylinder unit is provided in a shift-control unit removably arranged in the vehicle.

36. The system of claim 20, further comprising a spring element received in the bore, the spring element biasing the piston toward the operating position.

37. A method for mounting and demounting a cylinder unit in a vehicle, comprising:
providing a piston arranged in a bore of the cylinder unit, the piston including a piston rod configured to be moved in an axial direction through the bore, the piston separating the bore into a first chamber and a second chamber, and the cylinder unit being configurable in at least an operating position and a mounting/demounting position;
connecting a source of pressurized fluid to a first passage, the first passage being in fluid communication with the first chamber; and
regulating a level of the pressurized fluid in the first chamber such that introduction or removal of the pressurized fluid from the first chamber causes movement of the piston in the axial direction.

38. The method of claim 37, further comprising the steps of:
introducing the pressurized fluid into the first chamber such that the cylinder unit is brought into the mounting/demounting position; and
mounting or demounting the cylinder unit from the vehicle.

39. The method of claim 37, further comprising the step of:
removing the pressurized fluid from the first chamber such that the cylinder unit is brought into the operating position.

40. The method of claim 37, wherein a pressure in the first chamber is regulated in order to regulate a level of the pressurized fluid in the first chamber.

41. The method of claim 37, wherein the pressurized fluid is operably connected to the first passage from an external source.

42. The method of claim 41, wherein the step of regulating the level of pressurized fluid in the first chamber includes disconnecting the external source when the cylinder unit is in the mounting/demounting position.

43. The method of claim 41, wherein the step of regulating the level of pressurized fluid includes opening a valve to introduce the pressurized fluid into the first chamber and closing the valve when the cylinder unit is in the mounting/demounting position.

44. The method of claim 37, wherein the pressurized fluid is operably connected to the first passage from a source internal to the vehicle.

45. A system for mounting and demounting a cylinder unit in a vehicle, comprising:
a piston arranged in a bore of the cylinder unit, the piston including a piston rod configured to move in an axial direction through the bore, the piston separating the bore into a first chamber and a second chamber;
at least a first passage provided in fluid communication with the first chamber; and
the cylinder unit being configurable in at least an operating position and a mounting/demounting position, such that when pressurized fluid is introduced into the first chamber in the operating position, the cylinder unit is brought into the mounting/demounting position.

46. The system of claim 45, further comprising a spring element received in the bore such that the piston is biased toward the operating position.

47. The system of claim 45, wherein after installation or removal of the cylinder unit, the pressurized fluid is removed from the first chamber, and the piston is biased into the operating position.
